(19) United States
(12) Patent Application Publication
(10) Pub. No.: US 2022/0064899 A1
(43) Pub. Date: Mar. 3, 2022

(54) FORK LIFT ATTACHMENT FOR A FRONT END LOADER BUCKET

(71) Applicant: Graham Reid, Red Hill, Brisbane (AU)

(72) Inventor: Graham Reid, Red Hill, Brisbane (AU)

(21) Appl. No.: 17/422,930

(22) PCT Filed: Jan. 17, 2020
(86) PCT No.: PCT/AU2020/050021

§ 371 Date: Jul. 14, 2021

(30) Foreign Application Priority Data
Jan. 17, 2019 (AU) 2019900140

(51) Int. Cl. E02F 3/96

(52) U.S. Cl. CPC E02F 3/962; E02F 3/4075

(57) ABSTRACT

A fork attachment for use with a multi-purpose bucket to convert the bucket into a forklift, the bucket having a leading jaw and a trailing jaw with at least one of the jaws being adapted to move between an open position and a closed position during use, the attachment comprising: an elongate tine member having a length extending between a forward end and a rear end wherein the tine member is adapted to be positioned upon an outer surface of the leading jaw such that the forward end of the tine member extends beyond a leading edge of the leading jaw to allow a load to be supported on the leading bucket during use and wherein the rear end of the tine member comprises a connecting member that is adapted for being positioned and secured in between the jaws of the bucket in the closed position to support the load positioned on the tine by transferring at least a part of the load to a tongue portion of the connecting member that engages an underside of the trailing jaw to support the load positioned on the tine member and wherein the connecting member is structured to allow the tine member to pivot away from the leading jaw of the bucket when the connecting member is secured in between the jaws.

### TECHNICAL FIELD

This invention relates generally to a fork lift attachment to convert a multi-purpose bucket of a loader such as a front end loader into a fork lift. The invention also relates to providing a fork lift attachment that can be easily installed and removed without causing any damage to the bucket.

### BACKGROUND

Any references to methods, apparatus or documents of the prior art are not to be taken as constituting any evidence or admission that they formed, or form part of the common general knowledge.

In many industries it is desirable to use loaders as multi-functional pieces of equipment. Some of these loaders typically use a multi-purpose bucket and it is desirable to use the bucket for a variety of applications. Some of these buckets are clam shell buckets. Each bucket is formed from two jaws that are pivotally mounted to each other with their positions relative to each other being controlled by hydraulic cylinders. The bucket is then otherwise operated and moved as any regular bucket would be on a loader.

Fork lift attachments for regular buckets, such as the attachment described in U.S. Pat. No. 6,022,184 are known. Such a prior art attachment allows temporary conversion of a regular bucket to perform fork lift jobs. This conversion ability is very advantageous in that it allows a single piece of equipment to be used for different functions without a major investment in separate specialized equipment. One of the shortcomings of such a design is related to the use of semi-permanent bolts or other fasteners to secure the fork lift attachments to the bucket. The majority of non-permanent, clamp-on fork lift attachments typically include means for mounting a rear end of each fork to a substantially flat, bottom portion or “blade” of the loader bucket which extends immediately behind a cutting edge of the bucket. These mounting means commonly include a lower bearing surface for contacting a bottom surface of the bucket blade as well as a screw-type clamping means for contacting an upper surface of the bucket blade and securing the blade against the lower bearing surface. While the specifics of the mounting means vary with different fork attachments, all known fork attachments which use the screw-type clamps suffer from a common problem relating to damaging the loader bucket. Specifically, all known screw-type clamps tend to form a rigid connection with the blade of the loader bucket such that the clamping mechanism itself may cause significant damage to the loader bucket.

In view of the above, it is desirable to provide a forklift attachment that addresses some of the shortcomings of the prior art.

### SUMMARY OF INVENTION

In an aspect, the invention provides a fork attachment for use with a multi-purpose bucket to convert the bucket into a forklift, the bucket having a leading jaw and a trailing jaw with at least one of the jaws being adapted to move between an open position and a closed position during use, the attachment comprising: an elongate tine member having a length extending between a forward end and a rear end wherein the tine member is adapted to be positioned upon an outer surface of the leading jaw such that the forward end of the tine member extends beyond a leading edge of the leading jaw to allow a load to be supported on the leading bucket during use and wherein the rear end of the tine member comprises a connecting member that is adapted for being positioned and secured in between the jaws of the bucket in the closed position to support the load positioned on the tine by transferring at least a part of the load to a tongue portion of the connecting member that engages an underside of the trailing jaw to support the load positioned on the tine member and wherein the connecting member is structured to allow the tine member to pivot away from the leading jaw of the bucket.

In an embodiment, the connecting member comprises a dependent portion extending transversely relative to the tine member for being positioned and secured in between the jaws of the bucket when the jaws are in the closed position.

In an embodiment, the tongue portion extends outwardly and transversely relative to the dependent portion.

In an embodiment, the tongue portion engages an in-use underside surface of the trailing jaw of the bucket.

In an embodiment, the length of the tongue portion is equal to or greater than the average width of the tine member.

In an embodiment, the length of the tongue portion is at least two times the average width of the tine member.

In an embodiment, the connecting member is integrally formed, preferably welded, with the tine member.

In an embodiment, the tine member and the tongue portion lie in parallel planes and extend in mutually opposed directions.

In an embodiment, the connecting member and the tongue portion are mutually perpendicular.

In an embodiment, during use a top portion of the connecting member is attached at or adjacent the rear end of the tine member, the top portion being spaced away from an exposed surface of the trailing jaw to allow movement of the top portion of the connecting member towards the exposed surface of the trailing jaw when the tine member pivots away from the leading jaw of the bucket.

In an embodiment, the connecting member is attached to the tine member at a location spaced away from and adjacent said rear end of the tine member.

In an embodiment, the rear end of the tine member comprises an abutting lip that extends past the connecting member such that during use the abutting lip of the tine member abuts the trailing jaw.

In an embodiment, width of the lip is less than the width of the tongue member to allow the tine member to pivot away from the leading jaw.

In an embodiment, a load receiving surface of the tine member lies in a plane that extends between the front and rear end of the tine member.

In an embodiment, the tine member comprises a substantially flat profile such that thickness of the tine is substantially lesser than the width of the tine member.

In an embodiment, upon securement of the connecting member in between the jaws of the bucket, the fork attachment is movable along a slot defined by opposed edges of the jaws of the bucket to allow the position of the attachment to be varied.

In an embodiment, pivoting or tilting the tine member in an upward direction relative to the leading jaw allows the attachment to be movable along the slot defined by the opposed edges of the first and second jaws of the bucket.

In an embodiment, the tine member and the tongue portion are parallel to each other and the connecting member is transverse or perpendicular to the tine member and the tongue portion.

In an embodiment, the tine member, the connecting member and the tongue portion are integrally formed.

In an embodiment, the tongue portion is welded to the dependent portion of the connecting member.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a perspective view of a forklift attachment 100 in accordance with a first embodiment of the present invention.

FIG. 2 illustrates a bottom view of the forklift attachment 100.

FIG. 3 is a top view of the forklift attachment 100.

FIG. 4 is right hand side top perspective view of the forklift attachment 100.

FIG. 5 is an end perspective view of the forklift attachment 100.

FIG. 6 is a bottom perspective view of the forklift attachment 100.

FIG. 7 is a bottom view of the forklift attachment 100.

FIGS. 8 and 9 depict illustrations of a front loader bucket 10 in which the leading jaw 12 and trailing jaw 14 are shown in a closed and open position respectively.

FIG. 10 shows a forklift attachment 100 being positioned in a slot defined by opposed edges of the leading and trailing jaws 12 and 14 of the bucket 10.

FIG. 11 shows two of the forklift attachments 100A and 100B being positioned in between the jaws 12 and 14 in an initial position when the leading jaw 12 is slightly raised to define a gap between the jaws that allows the position of the forklift attachments 100A and 100B to be easily adjusted.

FIG. 12 depicts forklift attachments 100A in a pivoting configuration whereby the forklift attachment 100A is able to pivot away from the leading jaw 12.

FIG. 13 shows forklift attachments 100A and 100B in a first in-use secured position whereby the attachments 100A and 100B are spaced apart over a relatively longer length for lifting goods with wider or longer dimensions.

FIG. 14 depicts a second in-use secured position whereby the attachments 100A and 100B are spaced apart over a relatively smaller length for lifting goods with a relatively narrower or shorter dimensions.

### DETAILED DESCRIPTION OF PREFERRED EMBODIMENTS

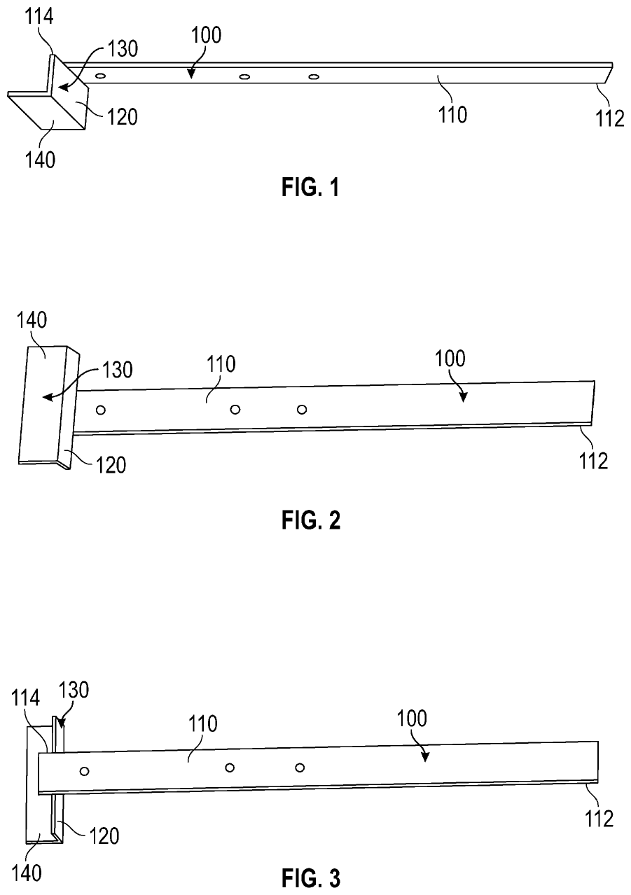

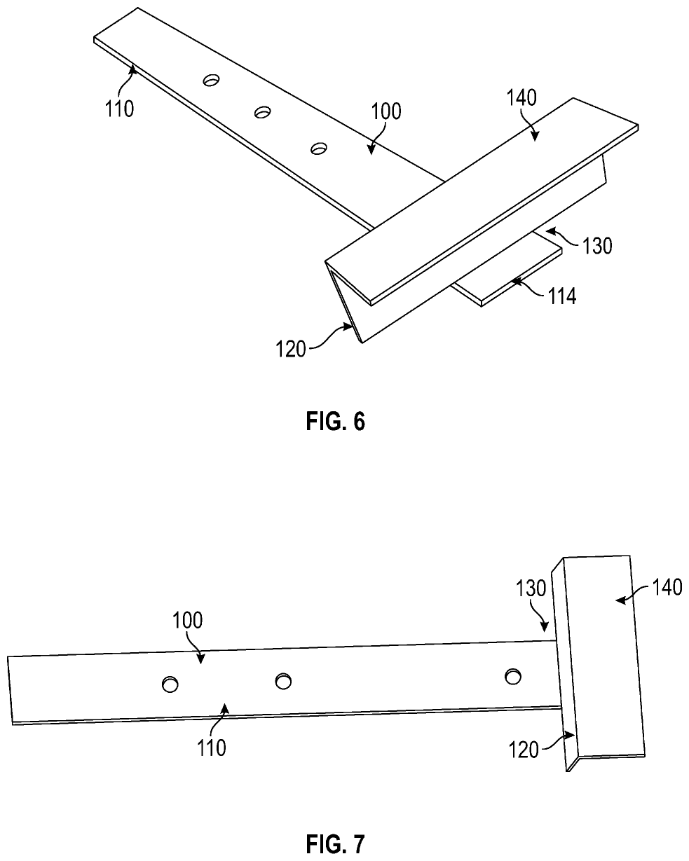

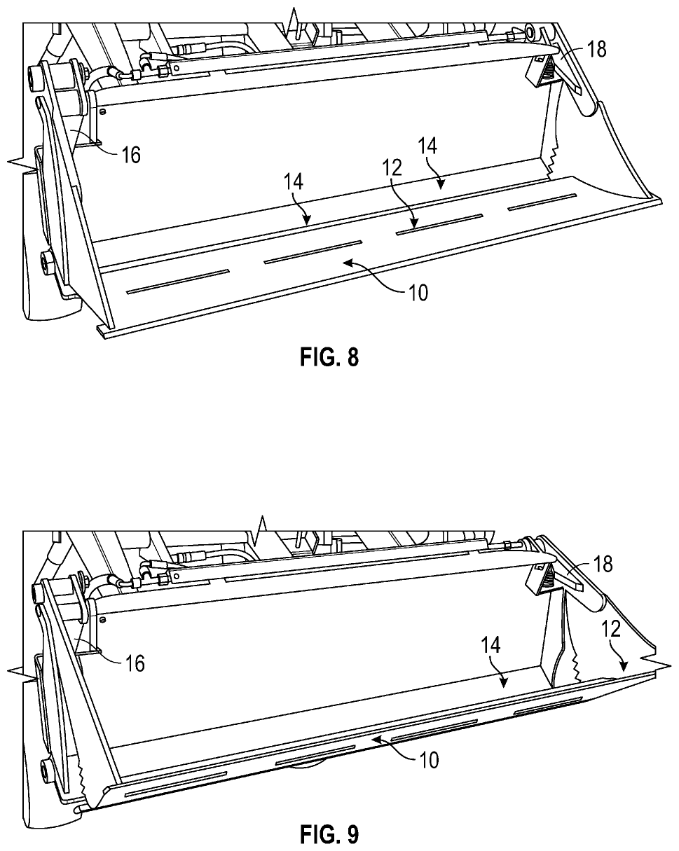

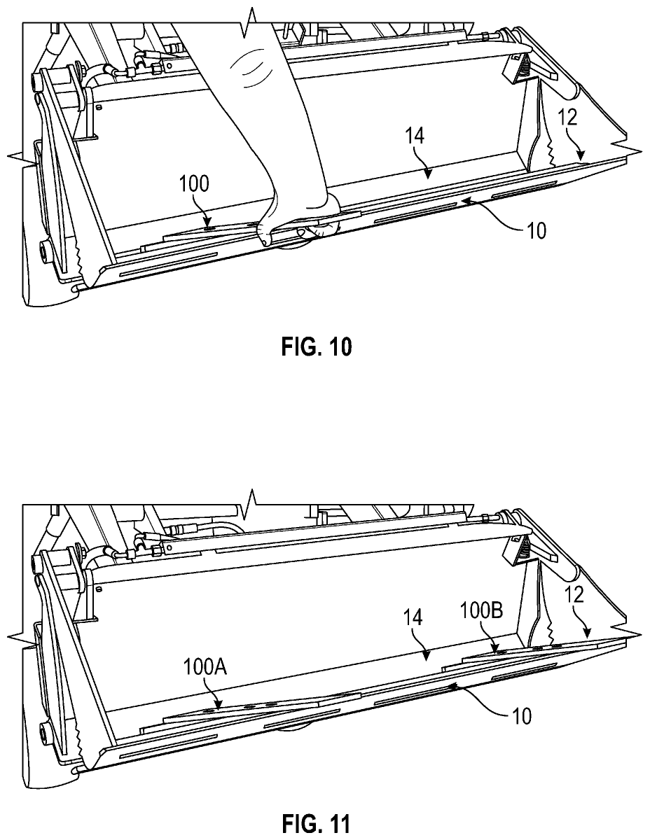

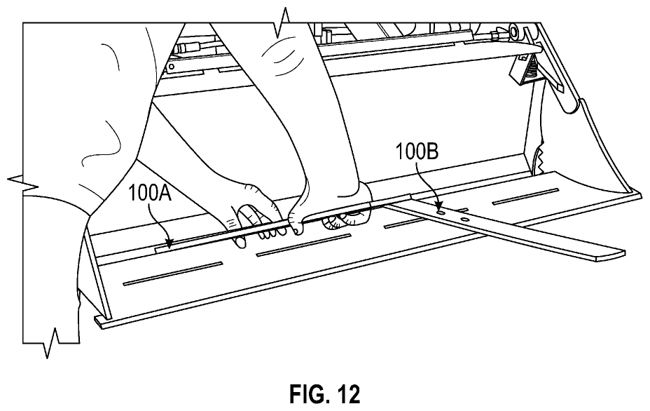

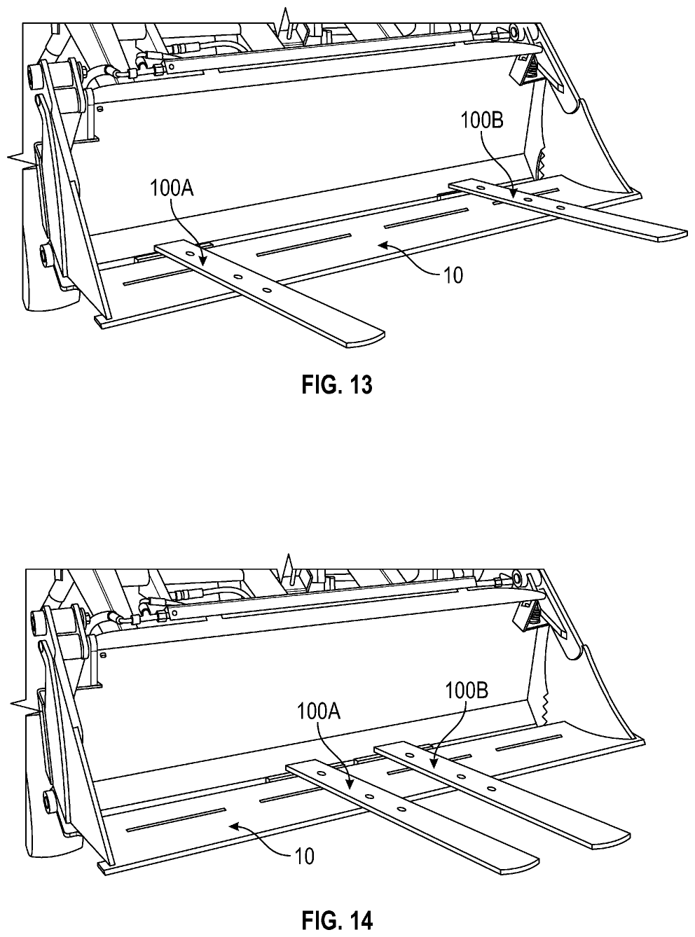

Referring to FIGS. 1 to 7, isolated views of the forklift attachment 100 for use with a multi-purpose bucket 10 (shown in FIGS. 8 to 14) of a front end loader have been illustrated. The forklift attachment 100 is particularly useful for converting a front end loader bucket 10 (isolated views of bucket 10 have been shown in FIGS. 13 and 14) into a forklift in accordance with a preferred embodiment have been illustrated. The attachment 100 is particularly suitable for use with buckets such as bucket 10 having a leading jaw 12 and a trailing jaw 14 (collectively referred to as jaws throughout the specification) that pivot between an open position and a closed position. FIGS. 10 to 14 illustrate the manner in which the forklift attachment 100 can be secured to the bucket 10 for converting the bucket 10 into a forklift. Views of the converted forklift have been shown in FIGS. 13 and 14.

Turning to FIGS. 10 and 11, the bucket 10 as a whole is moveable on arms that are typically present on front end loaders. The leading jaw 12 and the trailing jaw 14 are pivotally mounted to each other at attachment locations 16 and 18 and moveable relative to each other. In an opened position shown in FIG. 10, the leading jaw 12 when raised allows the trailing jaw 14 to be useable as a grader blade. The two jaws 12 and 14 in cooperation can also act as a claw for grasping and lifting and moving items in the field. In another configuration, the leading jaw 12 can act as a scraper for earth surface treatment. When the two jaws are closed without the fork attachment, it operates as a regular bucket. This versatility of such a typical multi-purpose bucket 10 is well known in the art.

Turning to FIGS. 1 to 7 in particular, each forklift attachment 100 comprises an elongate tine member 110 that extends between a forward end 112 and a rear end 114. The forklift attachment 100 also includes a connecting member 130 that is attached by welding or integrally formed with the tine member 110. The connecting member 130 is located adjacent the rear end 114 of the forklift attachment 100. The connecting member 130 is configured for being positioned in between the two pivotally attached jaws 12 and 14 of the bucket 10 when the jaws 12 and 14 are in a closed position. Detailed views of the bucket 10 without the forklift attachment have been shown in FIGS. 1 to 7. The provision of the connecting member 130 in the forklift attachment 100 allows the forklift attachment 100 to be secured in between the jaws 12 and 14 in the closed position. The novel configuration of the connecting member 130 is such that upon being positioned and secured in between the jaws 12 and 14 of the bucket 10 in the closed position, the tine member 110 becomes positioned on the leading jaw 12 to support the load positioned on the tine member by transferring at least a part of the load to a tongue portion 140 of the connecting member 130 that engages an underside of the trailing jaw 14 to support the load positioned on the tine member 110.

The connecting member 130 comprises a downwardly dependent portion 120 extending in an in-use downwardly direction relative to the tine member 110. During use, the downwardly dependent portion 120 of the connecting portion 130 is adapted to be positioned and held between the closed jaws 12 and 14 of the bucket 10. The downwardly dependent portion 120 also includes a tongue portion 140 that extends outwardly and transversely relative to the downwardly dependent portion 120. The tongue portion 140 is spaced away from the tine member 110 and extends outwardly in an opposite direction relative to the tine member 110. In other words, the tine member 110 and the tongue member 140 extend in mutually opposite directions and such that when the downwardly dependent member 120 is secured in between the closed jaws 12 and 14 of the bucket 10, the tongue portion 140 engages an underside of the upper jaw 12 whilst the tine member engages the upper surface of the leading jaw 14. Upon securement of the connecting member 130 in between the closed jaws 12 and 14 of the bucket 10, when a load is positioned on the tine 100, at least a part of that load is transferred to an underside surface of the trailing jaw 14 via the tongue portion 140. Specifically, positioning a load on the tine member 110 results in a slight upward movement of the tongue portion 140 to effect engagement between the tongue portion 140 and an underside surface of the trailing jaw 14. As a result, at least a part of the load is transferred to the trailing jaw 14 via the tongue portion 140.

Another important feature relates to the ability of the tine member 110 to pivot in an upwardly direction away from the leading jaw 12. This feature is beneficial when the jaws 12 and 14 of the bucket 10 are pointed in a downwardly direction which can inadvertently result in the forklift attachment 100 being pushed against an underlying surface. Such an accidental movement can not only cause damage to the forklift attachment 100 but also cause damage to the jaws 12 and 14 of the bucket 10. As will be explained in the foregoing sections, the connecting member 130 in the forklift attachment 100 is structured to allow the tine member 110 to pivot or lift upwardly in a direction away from the leading jaw 12 of the bucket 10 and as a result do not dig into the ground or floor during use. Such a feature reduces instances of inadvertent damage being caused to the jaws 12 and 14 and the forklift attachment 100.

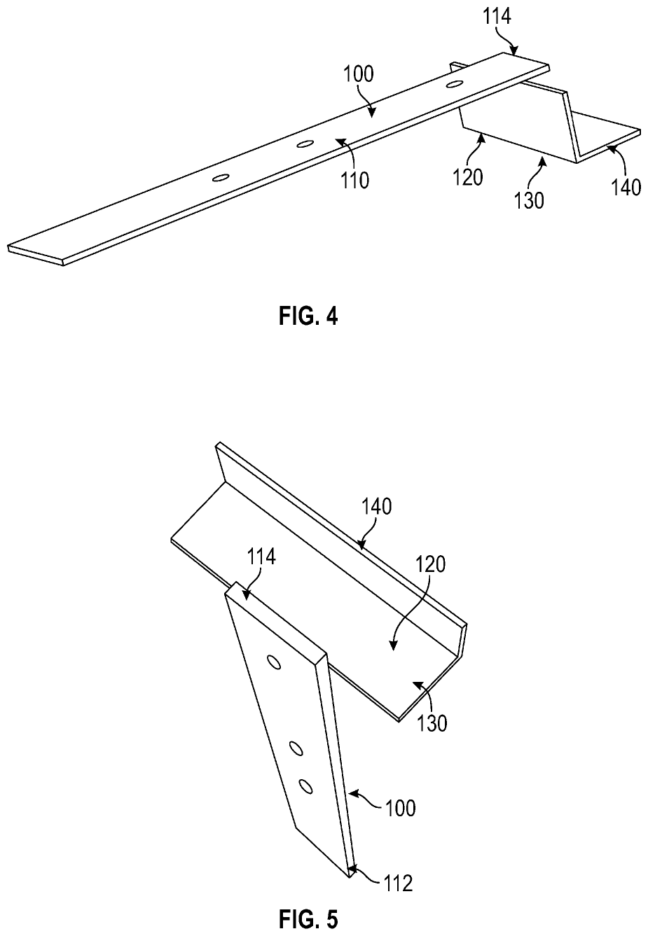

As shown in FIGS. 4 to 7, the tine member 110, the downwardly dependent portion 120 and the tongue member 140 define an “S” shaped configuration which allows the forklift attachment 100 to be effectively secured to the bucket 10 whilst also allowing the tine member 110 to pivot away from the leading jaw 12 of the bucket 10. The connecting member 130 also provides a configuration that allows quick installation of the forklift attachment 100 without requiring any fasteners or clamps which might otherwise damage the bucket 10.

It is also important to note that the connecting member 130, specifically an upper portion of the downwardly dependent portion 120 is preferably welded to the tine member 110 at a location that is adjacent the rear end 114 of the tine member 110. Welding the connecting member 130 adjacent the rear end 114 results in the end portion 114 of the tine member 110 overhanging or extending past the downwardly dependent portion 120 to form an abutting lip at the rear end 114. When the tine member 110 is loaded, an underside of the overhanging lip portion of the tine member 110 abuts an exposed surface of the trailing jaw 14 and further assists with securement of the forklift attachment 100 on with the jaws 12 and 14 of the bucket 10. However, when the tine member 110 is not loaded and an upward force (applied by the underlying ground or surface) pushes the tine member 110 upwards (away from the leading jaw 12), the overhanging lip portion becomes spaced away from the exposed upper surface of the trailing bucket 14 which allows the tine member 110 to pivot away from the leading jaw 12 and prevents any damage being caused to the forklift attachment 100 and the bucket 10. The width of the lip at the rear end 114 is less than the width of the tongue member 140 which further assists with increasing the extent (or angle) by which the tine member 110 can pivot relative to the closed jaws 120 and 14 of the bucket 10.

FIGS. 8 to 14 depict illustrations of the forklift attachment 100 being in use in conjunction with a bucket 10. Specifically, as shown in FIGS. 10 and 11, the leading jaw 12 needs to be raised sufficiently to allow the downwardly extending portion 120 of the connecting member 130 to be positioned anywhere along a slot defined by opposed edges of the leading and trailing jaws 12 and 14 of the bucket 10 to allow the position of the attachment 100 to be varied along the slot depending on the requirements of the application. Once the connecting member 130 of the forklift attachment 100 has been positioned along the slot, the leading jaw 12 is lowered to secure the attachment 100 in position between the trailing jaw 14 and the leading jaw 12 of the bucket 10.

FIGS. 10 to 14 depict two of the forklift attachments 100A and 100B (which are identical to attachment 100 as previously described) being used for converting the bucket 10 into a forklift. As previously described the location of the forklift attachments 100A and 100B may be varied along the slot defined by the opposed jaws of the upper jaw 14 and the lower jaw 12. The forklift attachment 100 may be easily removed by raising the lower jaw 12 of the bucket 10 and withdrawing the connecting member 130 out of the slot between the upper and lower jaws 12 and 14.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A fork attachment for use with a multi-purpose bucket to convert the bucket into a forklift, the bucket having a leading jaw and a trailing jaw with at least one of the jaws being adapted to move between an open position and a closed position during use, the attachment comprising: an elongate tine member having a length extending between a forward end and a rear end wherein the tine member is adapted to be positioned upon an outer surface of the leading jaw such that the forward end of the tine member extends beyond a leading edge of the leading jaw to allow a load to be supported on the leading bucket during use and wherein the rear end of the tine member comprises a connecting member that is adapted for being positioned and secured in between the jaws of the bucket in the closed position to support the load positioned on the tine by transferring at least a part of the load to a tongue portion of the connecting member that engages an underside of the trailing jaw to support the load positioned on the tine member and wherein the connecting member is structured to allow the tine member to pivot away from the leading jaw of the bucket when the connecting member is secured in between the jaws.

2. The fork attachment in accordance with claim 1 wherein the connecting member comprises a dependent portion extending transversely relative to the tine member for being positioned and secured in between the jaws of the bucket when the jaws are in the closed position.

3. The fork attachment in accordance with claim 2 wherein the tongue portion extends outwardly and transversely relative to the dependent portion.

4. The fork attachment in accordance with claim 1 wherein the tongue portion engages an in-use underside surface of the trailing jaw of the bucket.

5. The fork attachment in accordance with claim 1 wherein the length of the tongue portion is equal to or greater than the average width of the tine member.

6. The fork attachment in accordance with claim 5 wherein the length of the tongue portion is two times the average width of the tine member.

7. The fork attachment in accordance with claim 1 wherein the connecting member is integrally formed, preferably welded, with the tine member.

8. The fork attachment in accordance with claim 1 wherein the tine member and the tongue portion lie in parallel planes and extend in mutually opposed directions.

9. The fork attachment in accordance with claim 1 wherein the connecting member and the tongue portion are mutually perpendicular.

10. The fork attachment in accordance with claim 1 wherein during use a top portion of the connecting member is attached at or adjacent the rear end of the tine member, the top portion being spaced away from an exposed surface of the trailing jaw to allow movement of the top portion of the connecting member towards the exposed surface of the trailing jaw when the tine member pivots away from the leading jaw of the bucket.

11. The fork attachment in accordance with claim 1 wherein the connecting member is attached to the tine member at a location spaced away from and adjacent said rear end of the tine member.

12. The fork attachment in accordance with claim 11 wherein the rear end of the tine member comprises an abutting lip that extends past the connecting member such that during use the abutting lip of the tine member abuts the trailing jaw.

13. The fork attachment in accordance with claim 12 wherein width of the lip is less than the width of the tongue member to allow the tine member to pivot away from the leading jaw.

14. The fork attachment in accordance with claim 1 wherein a load receiving surface of the tine member line in a plane that extends between the front and rear end of the tine member.

15. The fork attachment in accordance with claim 1 wherein the tine member comprises a substantially flat profile such that thickness of the tine is substantially lesser than the width of the tine member.

16. The fork attachment in accordance with claim 1 wherein upon securement of the connecting member in between the jaws of the bucket, the fork attachment is movable along a slot defined by opposed edges of the jaws of the bucket to allow the position of the attachment to be varied.

17. The fork attachment in accordance with claim 1 wherein pivoting or tilting the tine member away from the leading jaw allows the attachment to be movable along the slot defined by the opposed edges of the first and second jaws of the bucket.

18. The fork attachment in accordance with claim 1 wherein the tine member and the tongue portion are parallel to each other and the connecting member is transverse or perpendicular to the tine member and the tongue portion.

19. The fork attachment in accordance with claim 1 wherein the tine member, the connecting member and the tongue portion are integrally formed.

20. The fork attachment in accordance with claim 1 wherein the tongue portion is welded to the dependent portion of the connecting member.
